(19) United States
(12) Patent Application Publication
(10) Pub. No.: US 2015/0095880 A1
(43) Pub. Date: Apr. 2, 2015

(54) FACILITATING SOFTWARE DEVELOPMENT TOOLS ON MOBILE COMPUTING DEVICES IN AN ON-DEMAND SERVICES ENVIRONMENT

(71) Applicant: salesforce.com, inc., San Francisco, CA (US)

(72) Inventor: JU HAE LEE, San Francisco, CA (US)

(21) Appl. No.: 14/498,869

(22) Filed: Sep. 26, 2014

Related U.S. Application Data
(60) Provisional application No. 61/883,361, filed on Sep. 27, 2013.

(51) Int. Cl. G06F 9/44; G06F 9/445; G06F 11/36

(52) U.S. Cl. CPC G06F 8/30; G06F 11/3688; G06F 8/60
USPC 717/108

(57) ABSTRACT

In accordance with embodiments, there are provided mechanisms and methods for facilitating dynamic software development tools on mobile computing devices in an on-demand services environment in a multi-tenant environment according to one embodiment. In one embodiment and by way of example, a method includes initiating an application building tool to generate a new software application for a computing device. The application building tool may be accessible via a user interface at the computing device including a mobile computing device or one or more other computing devices. The method may include providing a software development environment to facilitate user interactions based on the new software application, where each user interaction is associated with one or more objects in an on-demand services environment.

### CLAIM OF PRIORITY

This application claims the benefit of and priority to U.S. Provisional Patent Application No. 61/883,361, entitled “Tool for Generating Applications on Mobile Devices for Users of On-Demand Services Environment” by Ju Hae Lee, filed Sep. 27, 2013, Attorney Docket No.: 8956P225Z, and the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating software development tools on mobile computing devices in an on-demand services environment.

### BACKGROUND

Mobile computing devices have proliferated in recent years, making mobile software development imperative for businesses. However, conventional techniques provide interfaces that require professional experts, such as software programmers, graphics designers, etc., to build and deploy software applications on mobile computing devices; accordingly, such conventional techniques are cumbersome, inefficient, time-consuming, and expensive.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a dynamic software development mechanism according to one embodiment;

FIG. 2 illustrates a dynamic software development mechanism and an application building tool according to one embodiment;

FIG. 3A illustrates a computing device hosting an application building tool according to one embodiment;

FIGS. 3B-3D illustrate screenshots of a user interface illustrating application building processes using an application building tool according to one embodiment;

FIG. 4A illustrates a method for facilitating dynamic software development at a mobile computing device according to one embodiment;

FIG. 4B illustrates a method for facilitating dynamic software development at a mobile computing device according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating software development tools on mobile computing devices in an on-demand services environment in a multi-tenant environment according to one embodiment. In one embodiment and by way of example, a method includes initiating an application building tool to generate a new software application for a computing device. The application building tool may be accessible via a user interface at the computing device including a mobile computing device or one or more other computing devices. The method may include providing a software development environment to facilitate user interactions based on the new software application, where each user interaction is associated with one or more objects in an on-demand services environment.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating dynamic software development tools on mobile computing devices in an on-demand services environment in a multi-tenant environment according to one embodiment.

Embodiments provide for a mechanism to facilitate, in an on-demand services environment, a platform to enable users to build and deploy mobile applications at mobile devices. A mobile platform application may be provided to users of on-demand services environment such that mobile applications may be generated and deployed on multiple types of mobile devices, such as tablet computers, smartphones, wearable devices, touch-enabled devices, etc., operating on any number and type of operating systems.

Further, for example and in one embodiment, using an application running on a platform provided by the on-demand services environment, such as HEROKU®, a user may build a mobile application by acceding a user interface, such as a what-you-see-is-what-you-get (“WYSIWYG”) user interface. Certain events or features may be associated with images, such as HyperText Markup Language (“HTML”), etc., and components, such as Visualforce® components, etc., that may rely on data residing in the on-demand services environment. It is contemplated that embodiments are not limited to any particular number or type of operating systems, such as Apple® iOS®, Android®, etc. Similarly, it is contemplated that any number and type of libraries (e.g., jQuery, AngularJS, KineticJS, NodeJS, ExpressJS, HammerJS, iScroll, etc.) may be used to generate new software applications at mobile computing devices in an on-demand services environment.

It is contemplated that embodiments and their implementations are not merely limited to multi-tenant database system (“MTDBS”) and can be used in other environment, such as a client-server system, a mobile device, a personal computer (PC), a web services environment, etc. However, for the sake of brevity and clarity, throughout this document, embodiments are described with respect to a multi-tenant database system, such as Salesforce.com®, which is to be regarded as an example of an on-demand services environment.

In conventional models, index tables are severely limited in that an index table can only be created, for example, by a limitation of up to two columns and each column with up to three data types. As a result, a large number of index tables and/or skinny tables are required to be created and maintained and further, when they are relied upon for reference (such as when customer queries are to be processed) which can all be expensive, inefficient, and not scalable.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

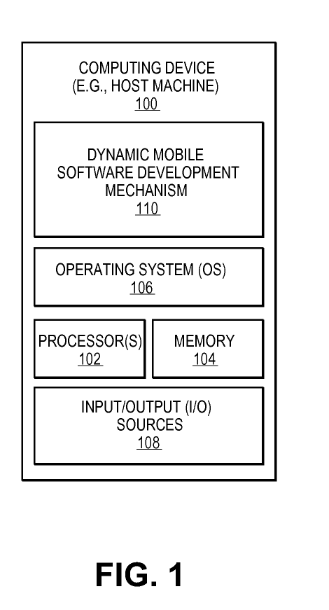

FIG. 1 illustrates a computing device 100 employing a dynamic mobile software development mechanism 110 according to one embodiment. In one embodiment, computing device 100 serves as a host machine for employing dynamic mobile software development mechanism (“mobile mechanism”) 110 for dynamically facilitating generation and deployment of software applications at mobile computing devices in a multi-tiered, multi-tenant, on-demand services environment.

The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of mobile mechanism 110 or an organization's representative, such as a salesperson, a sales manager, a product manager, an accountant, a director, an owner, a president, a system administrator, a computer programmer, an information technology (“IT”) representative, etc.

It is to be noted that any references to software codes, data and/or metadata (e.g., Customer Relationship Model (“CRM”) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit™ (“Integration Toolkit” or “Toolkit”), Platform on a Service™ (“PaaS”), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

Computing device 100 may include server computers (e.g., cloud server computers, etc.), desktop computers, cluster-based computers, set-top boxes (e.g., Internet-based cable television set-top boxes, etc.), and the like. Computing device 100 may also include smaller computers, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (“PDAs”), etc., tablet computers (e.g., iPad® by Apple®, Galaxy® by Samsung®, etc.), laptop computers (e.g., notebooks, netbooks, Ultrabook™ systems, etc.), e-readers (e.g., Kindle® by Amazon.com®, Nook® by Barnes and Nobles®, etc.), media internet devices (“MIDs”), smart televisions, television platforms, wearable devices (e.g., glasses (e.g., Google® Glass® by Google®, watches, bracelets, smartcards, jewelry, clothing items, etc.), media players, Global Positioning System (“GPS”)-based navigation systems, cable setup boxes, etc.

Computing device 100 includes an operating system (“OS”) 106 serving as an interface between any hardware or physical resources of the computing device 100 and a user. Computing device 100 further includes one or more processors 102, memory devices 104, network devices, drivers, or the like, as well as input/output (“I/O”) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “code”, “software code”, “application”, “software application”, “program”, “software program”, “package”, “software code”, “code”, and “software package” may be used interchangeably throughout this document. Moreover, terms like “job”, “input”, “request” and “message” may be used interchangeably throughout this document. It is to be further noted that terms like “build”, “generate”, “create”, “develop”, “make”, or the like, and any of their variations, such as “building”, “generating”, “creating”, developing”, “making”, respectively, may be referenced interchangeably throughout this document.

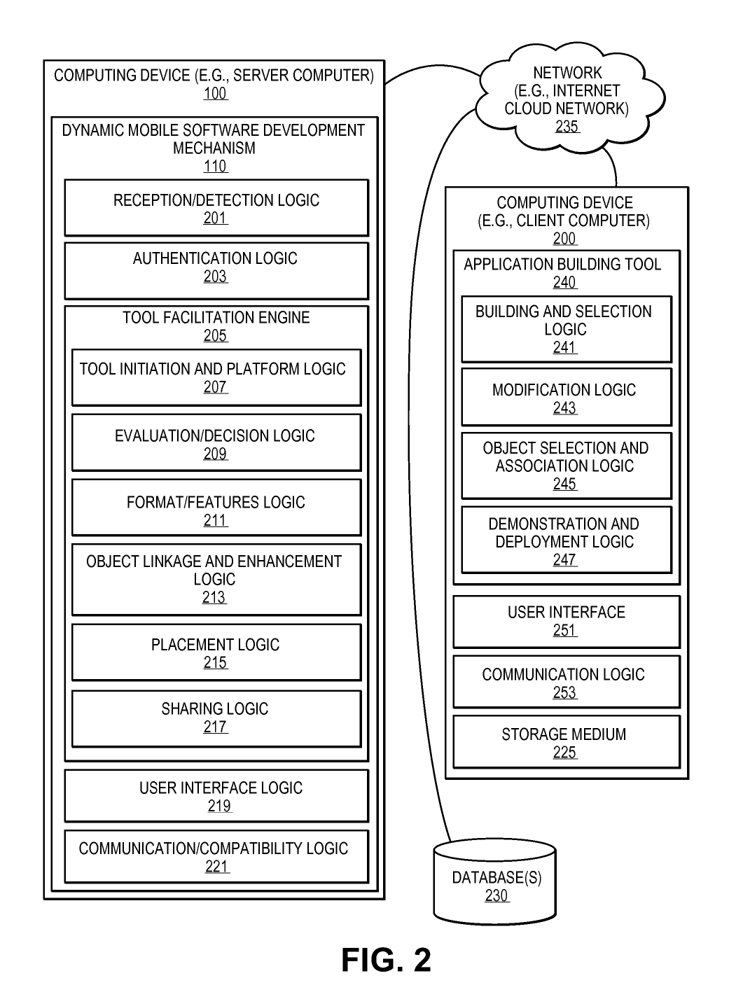

FIG. 2 illustrates a dynamic software development mechanism 110 and an application building tool 240 according to one embodiment. In one embodiment, mobile mechanism 110 may include a number of components, such as (without limitation): detection/reception logic 201; authentication logic 203; tool facilitation engine 205 including tool initiation and platform logic (“platform logic”) 207, evaluation/decision logic 209, format/features logic 211, object linkage and enhancement logic (“linkage logic”) 213, placement logic 215, and sharing logic 217; user interface logic 219; and communication/compatibility logic 221.

In one embodiment, computing device 100 may include a server computer which may be further in communication with one or more databases or storage repositories, such as database 230, which may be located locally or remotely over one or more networks, such as network 235 (e.g., cloud network, Internet, proximity network, intranet, Internet of Things (“IoT”), Cloud of Things (“CoT”), etc.). Embodiments may not be limited to any particular type of data storage repositories or any particular amount and type of contents stored at such repositories. However, as an example and for the sake of brevity, clarify, and ease of understanding, throughout the document, database 230 may be regarded as a data storage repository for storing and maintaining, for example, software codes, newly-built applications, existing objects, such as existing applications, other content or data, etc.

Computing device 100 may be further in communication with any number and type of other computing devices, such as computing device 200, over one or more networks, such as network 235. As aforementioned with reference to computing device 100 of FIG. 1, computing device 200 may include a client computer, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (“PDAs”), etc., tablet computers (e.g., iPad® by Apple®, Galaxy® by Samsung®, etc.), laptop computers (e.g., notebooks, netbooks, Ultrabook™ systems, etc.), e-readers (e.g., Kindle® by Amazon.com®, Nook® by Barnes and Nobles®, etc.), media internet devices (“MIDs”), smart televisions, television platforms, wearable devices (e.g., glasses (e.g., Google® Glass® by Google®, watches, bracelets, smartcards, jewelry, clothing items, etc.), media players, Global Positioning System (“GPS”)-based navigation systems, cable setup boxes, etc.

As illustrated, in one embodiment, computing device 200 may host a client-based application builder, such as application building tool (“building tool”) 240, which may include any number and type of components, such as (without limitation): building and selection logic (“building logic”) 241; modification logic 243; object selection and association logic (“object logic”) 245; and demonstration and deployment logic (“demo and deploy logic”) 247. Computing device 200 may further include (without limitation) user interface 251, communication logic 253, storage medium 255, etc.

Throughout this document, terms like “logic”, “component”, “module”, “framework”, “engine”, “tool”, and “builder” may be referenced interchangeably and include, by way of example, software, hardware, and/or any combination of software and hardware, such as firmware. Further, any use of a particular brand, word, or term, such as “cryptography”, “public key”, “private key”, “signature”, “fingerprint”, “repository” or “database”, “code” or “software code”, “development platform”, “development environment”, “application builder” or “application building tool”, etc., should not be read to limit embodiments to software or devices that carry that label in products or in literature external to this document.

In one embodiment, mobile mechanism 110 facilitates building tool 240 at computing device 200 to allow for a user (e.g., end-user, such as a sales representative, an accountant, an administrator, etc.) to create and deploy a mobile software application at a mobile computing device, such as computing device 200, without have the need to obtain any help from an expert (e.g., software developer, system administrator, etc.) or source code and the like. For example, user interface logic 221 may facilitate one or more user interfaces, such as user interface 251, at computing device 200 such that user interface 251 (e.g., Internet browser, Photoshop-like interface, WYSIWYG interface, etc.) may be used to access application building tool 240 to generate one or more software applications to be deployed and used at computing device 200.

Having accessed application building tool 240, the request for building an application may be received at reception/detection logic 201 and upon receiving the request, the user and/or computing device 200 may be verified or authenticated by authentication logic 203 via, for example, user/device identification (“user ID”), password, signature, fingerprint, private cryptographic key, public cryptographic key, etc. In some embodiments, when a new user or a new computing device attempts to use application building tool 240, the user may be requested to register by providing relevant data (e.g., name, title, employee number, organization name, etc.) prior to generating access credentials, such as userID, password, passcode, etc. Upon successful registration and/or authentication of the user and/or computing device 200, the user may then be allowed to access building tool 240 via user interface 251 to generate a software application.

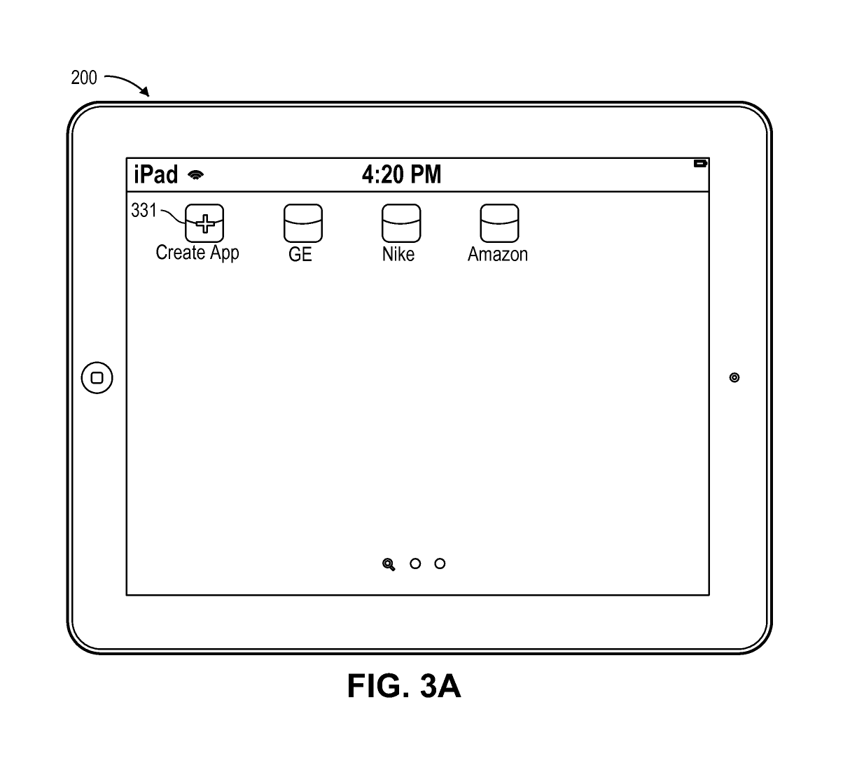

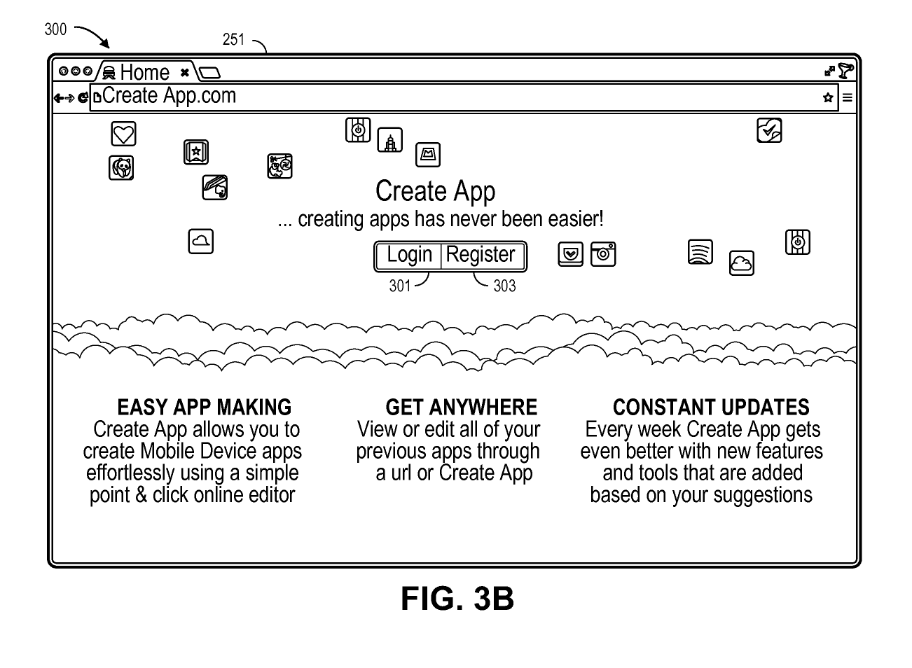

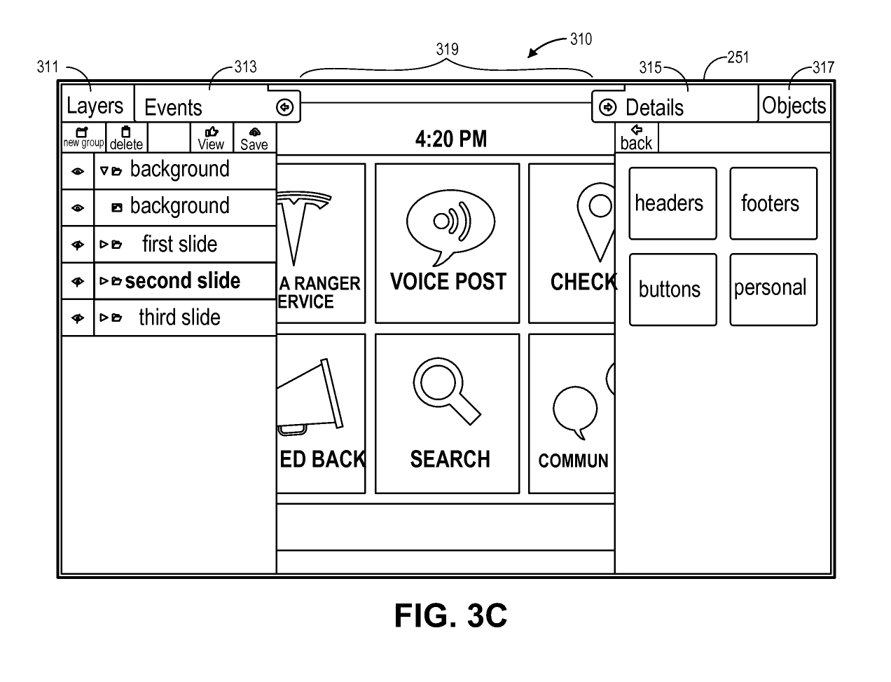

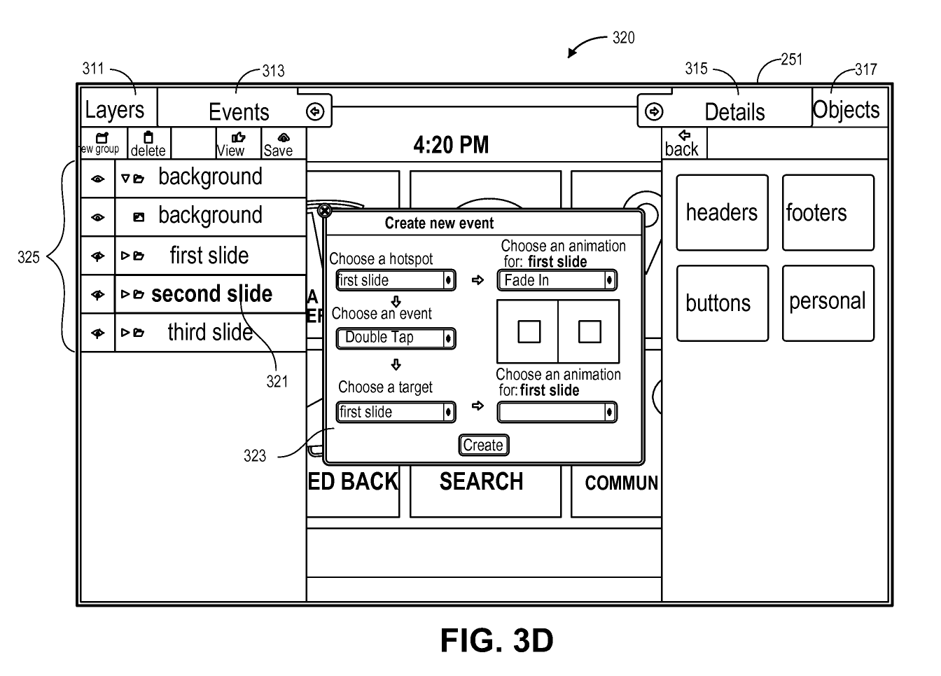

In one embodiment, platform logic 207 of tool facilitation engine 205 may initiate access building tool 240 to be used by the user to generate a mobile application. For example, the initiation process may include loading or reloading of various screens, processes, pictures, audios, videos, etc., that may be used by the user to successfully perform various tasks leading to generation and deployment of the application at computing device 200. For example and in one embodiment, as shown with regard to screenshots of FIG. 3A-3D, upon logging into building tool 240, the user may be given options of using and choosing from various relatively easy processes, drop-down menus, building blocks, etc., as facilitated by building logic 241, for application generation and deployment. For example, if the user wishes to generate an mobile software application that may be used to give a sales pitch regarding a particular product to a particular client, many of the pictures, sales data, video streams, audios, graphics, designs, etc., may be preloaded that may simply be viewed and either accepted or rejected, as desired or necessitated, by the user.

Further, in one embodiment, platform logic 207 may also be used to provide a relevant software development platform for mobile application generation and deployment at computing device 200. For example, in some embodiments, platform logic 207 may provide a cloud-based platform (e.g., platform at a service (“PaaS”), such as Heroku®), supporting any number and type of programming languages (e.g., Ruby™, Java™, Paython™, Clojure™, Perl™, etc.) such that the user may be offered various pre-programmed and easy-to-use processes, drop-down menus, building blocks, etc., via user interface 251 for easy development and deployment of mobile applications at computing device 200.

As shown in FIGS. 3A-3D, in one embodiment, as facilitated by format/features logic 211, the user may be displayed a number of pre-loaded format options to choose from to easily create a new application without having to perform any programming or code development. As aforementioned and as facilitated by format/features logic 211 in communication with building logic 241, these pre-loaded selection of format options may be provided to the user, via user interface 251, and include (without limitation) any number and type of features, such as colors, background designs, animation formats, facts and figures regarding a product that the user may wish to promote, audio/video streams, photos, etc., from which the user may select, step-by-step, any number and type of options, and continue to generate the new application.

Similarly, in communication with and as facilitated by format/features logic 211, any number and type of feature options may also be preloaded and then provided by building logic 241 via user interface 251. Such feature options may include support for any number and type of event or action features (also simply referred to as “events”), such as touch, swipe, click, zoom-in, zoom-out, etc. As with the format options, the user may choose any number and type of feature options to prepare and deploy the software application. In one embodiment, upon selection of any number and type of format and feature options, each selection may then be received at reception/detection logic 201 as communicated over network 235 and via communication/compatibility logic 221 and communication logic 253. These selections received at reception/detection logic 201 are then communicated to evaluation/decision logic 209 where they are evaluated for any number of factors and decided whether to be accepted or rejected.

For example and in one embodiment, each selection may be evaluated for various factors (e.g., authenticity, relevancy, availability, legality, morality, sensibility, etc.), such as when the user, acting on behalf of an organization (e.g., company, corporation, business, academic institution, non-profit entity, government agency, etc.), selects a particular animation for the new application that is intended to be used to promote the organization's product to a potential client (e.g., another organization, such as a company, etc.), the animation may be rejected by evaluation/decision logic 209 based on a predetermined policy that the selected animation may not be used for that particular product and/or potential client. For example, a particular animation may be regarded as offensive in certain counties and if the potential client is associated with or maintains presence in that particular country, the selected animation may be automatically rejected by evaluation/decision logic 209 as being inappropriate.

However, the user may then be encouraged and recommended to either amend the selected animation or simply select another animation or one or more of the other format/feature options, etc. In one embodiment, such predetermined policies may be determined by one or more individuals, such as one or more managers, administrators, policy makers, sales representatives, etc., and entered or implemented as part of mobile mechanism 110 by another set of one or more individuals, such as system administrators, software developers, programmers, etc., based on or according to the predetermined policy.

Although the user may choose from various number and types of pre-loaded format/features options in order to generate the desired software application; in some embodiments, the user may choose to modify some of the pre-loaded options and/or add some of own options. For example, the user may choose to add own video or voice to personalize the software application so that a more personalized sales pitch may be made to the potential client. As aforementioned, it is contemplated that embodiments are not limited to sales or generating sales-related applications and that embodiments may be used for generating any number and type of software applications for use with any number and type of fields and reasons, etc.

Accordingly, in some embodiment, modification logic 243 provides customization options such that user may choose to customize the software application by inserting own format/features options, such as videos, audios, pictures, animations, symbols, colors, backgrounds, functions, processes, touch/swipe actions, etc., for any number of reasons, such as to further customize the application, personalize the application, add relevant or supporting data to the application, providing better visuals, animations, sounds, videos, etc. Similarly, modification logic 243 provides modification options such that the user may choose to modify some of the pre-loaded formatting/features options, such as changing the font size or type, animation colors or characters, etc. Any such additions or modifications may be received at reception/detection logic 201 and then evaluated and decided by evaluation/decision logic 209. As aforementioned, evaluation/decision logic 209 may evaluate the new additions and/or modifications and decide on whether they are accepted to be included in the application or rejected as such.

Furthermore, in one embodiment, linkage logic 213 of mobile mechanism 110 may provide options of linking the new software application with one or more objects in the on-demand service environment, such as linking with one or more existing software applications, one or more databases 230, to further enhance the new application. In one embodiment, linking may refer to associating the new software application with one or more existing software applications and/or contents at one or more databases, such as database 230, etc. In another embodiment, linking may refer to partially or fully merging the new application with one or more existing applications and/or contents at one or more databases 230, such as contents from an existing application and/or databases 230 may be imported into the new application. In yet another embodiment, linking may further refer to partially or fully overwriting contents of the new application with contents of an existing application or vice versa.

In one embodiment, object logic 245 of building tool 240 may be facilitated by linkage logic 213 to provide one or more of the aforementioned linking options, via user interface 251, such that one or more interfaces may be established between the new application and one or more existing applications and/or one or more databases 230 that are chosen to be linked together. For example, the user may be provided, via user interface 251, a simplified and easy-to-navigate set of blocks, list of options, drop-down menus, etc., such that the user may choose any number and type of existing applications and/or databases 230 for linking with the new application.

For example, if the purpose of the new application is for the user to do a sales presentation for a product to a potential client (e.g., Coke®), then it might make sense for the user to link to an existing application relating to an existing client (e.g., Pepsi®) having products in similar category (e.g., soft drinks). Similarly, as aforementioned, the linkage may be extended to certain contents stored at one or more repositories, such as one or more databases 230, to be able to access, select, and import any amount and type of relevant data (e.g., positive impact of the product (that the user is attempting to sell to Coke®) on Pepsi®'s sales, accounting, resource management, etc.) in order to provide additional support for further enhancing one or more features, arguments, presentations already contained in the new application. This is because, for example, the potential client might find it interesting as to see how the existing client is benefiting from using the same product that is being pitched to the potential client.

In one embodiment, linking and enhancing, as facilitated by linkage logic 213, may include any number of forms in which an association or interface to one or more existing applications, databases 230 may be provided as selected and associated by the user using object logic 245 of building tool 241, via user interface 251, at computing device 200. In one embodiment, the new application may simply provide an interface into one or more existing applications and/or databases 230 so that the two applications may be linked to be enhanced, as necessitated or desired. In another embodiment, the new application may be partially substituted with contents of one or more existing applications and/or databases 230 to further enhance the new application. In yet another embodiment, the new application may be merged with one or more existing applications and/or databases 230 to further enhance the new application. In yet another embodiment, the new application may be generated by entirely using or based on contents of an existing application where only the basic information, such as names, dates, etc., may be provided by the user while the rest of the contents or information in the new application may be that of the existing application.

Once the new application has been created, demo and deploy logic 247 as facilitated by placement logic 215, may offer an option, via user interface 251, to allow the user to choose to run a demonstration (or simply “demo”) of the new application to test and determine how the application may perform if deployed on computing device 200. This way, any potential problems, bugs, deficiencies, improvements, enhancements, etc., in the new application may be detected and then fixed and/or performed prior to actual deployment of the application at computing device 200. Once the new application has been tested through demonstration, the user may then choose to deploy the new application via user interface 251 and using demo and deploy logic 247 as further facilitated by placement logic 215.

In one embodiment, the user may choose to share the newly developed software application wither other users or colleagues, department personnel, other potential clients, general public, etc., using one or more communication applications/websites, such as (without limitation) by posting the new application or its corresponding link on one or more communication or social/business network websites (e.g., Chatter®, LinkedIn®, Facebook®, etc.), sending it via an email application (e.g., Gmail®, Outlook®, etc.) or a text or short message service (“SMS”)-based application, downloading or uploading the new application on one or more computing devices (e.g., tablet computers, smartphones, laptop computers, desktop computers, server computers, etc.), etc., via user interface 251 and as facilitated by sharing logic 217.

In one embodiment, this option to communicate/share the new application may be provided or facilitated by sharing logic 217 such that it may be used and applied by the user at computing device 200 via user interface 251 and as facilitated by communication logic 253. Further, for example, this communicating/sharing option may be provided by sharing logic 217 in a simplified manner, such as the user may be allowed to choose to share the new application by simply clicking on one or more application/website icons, such as Facebook® icon, LinkedIn® icon, Chatter® icon, Outlook® icon, etc., and then follow the subsequent steps as provided via user interface 251 and facilitated by communication logic 253 at computing device 200.

Communication/compatibility logic 221 may facilitate the ability to dynamically communicate and stay configured with any number and type of software/application developing tools, models, data processing servers, database platforms and architectures, programming languages and their corresponding platforms, etc. Communication/compatibility logic 221 further facilitates the ability to dynamically communicate and stay configured with various computing devices (e.g., server computing device, mobile computing devices, such as smartphones, tablet computers, laptop, etc.), databases, repositories, networks (e.g., cloud network, intranet, the Internet, proximity network, such as Bluetooth®, WiFi®, etc.), websites (e.g., social/business networking websites, such as Chatter®, Facebook®, LinkedIn®, Google+®, Twitter®, etc.), etc., while ensuring compatibility with changing technologies, parameters, protocols, standards, etc.

It is contemplated that any number and type of components may be added to and/or removed from mobile mechanism 110 and/or building tool 240 to facilitate various embodiments including adding, removing, and/or enhancing certain features. For brevity, clarity, ease of understanding, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

Now referring to FIG. 3A, it illustrates computing device 200 hosting application building tool 240 of FIG. 2 according to one embodiment. For example, as illustrated, computing device 200 may be a tablet computer (e.g., iPad®, as illustrated) and building tool 240 of FIG. 2 may be represented as an application icon, such as icon 331 (e.g., Create App, as illustrated). In one embodiment, the user may simply click on an application icon, such as icon 331, to open or initiate building tool 240 of FIG. 2, staring with registration and/or login and then moving on to performing other subsequent processes as illustrated in FIG. 3B and previously described with reference to FIG. 2. It is contemplated that icon 331 may be saved with any name or title and that the name Create App is merely illustrated as an example. Similarly, as aforementioned, computing device 200 is not limited to tablet computers and that this iPad is illustrated here merely as an example as further discussed with reference to FIG. 2.

Now referring to FIG. 3B, it illustrates a screenshot 300 showing a user interface 251 according to one embodiment. In the illustrated embodiment, user interface 251 includes an Internet browser-based interface which may be accessed from a computing device, such as computing device 200 of FIG. 2. It is contemplated, however, that user interface 251 is not limited to an Internet browser-based interface and that other types of interfaces may be employed, such as a Photoshop-like interface, a WYSIWYG interface, etc. Further, for example, in the illustrated embodiment, a new user may choose to register by clicking on register 303 to provide any amount and type of information to registration purposes, such as user name, unique identification, employee number, organization name, user/organization address, etc. Once registered, the user may then login by clicking on login 301and providing login-related information, such as userID, password, etc. Similarly, an existing user may simply login by clicking on login 301 and continue with entering the login-related information. Once received at reception/detection logic 201, the information provided though the registration and/or login processes may then be used and verified by authentication logic 203 of FIG. 2 for verifying and authenticating the user prior to initiating mobile software application development and deployment as described with reference to FIG. 2.

FIG. 3C illustrates a screenshot 310 of interface 251 illustrating application building processes using application building tool 240 of FIG. 2 according to one embodiment. As illustrated and aforementioned, using building tool 240 as facilitated by mobile mechanism 110 of FIG. 2, a software application may be generated and deployed at a mobile computing device without having to employ a software developer, etc., and/or develop or deploy a source code. Accordingly, as illustrated and further discussed with reference to FIG. 2, a new software application may be generated by the user by simply clicking on and choosing along various simplified and easily available and displayed options, such as format options 319 (e.g., posting audio, video, etc.), layers 311 (e.g., themes, functions, etc.), features or events 313 referring to various features (e.g., background, slide, touch, swap, tap, etc.), details 315 (e.g., headers, footers, buttons, personal, etc.), and objects 317 (e.g., existing software applications, databases, such as databases 230 of FIG. 2, etc.) for liking and enhancement purposes, etc. These options may be provided as blocks, drop-down menus, lists, etc., which may be used by any user without having a need for employing a professional, like a software developer, or a developing a source code, etc.

FIG. 3D illustrates a screenshot 310 of interface 251 illustrating application building processes using application building tool 240 of FIG. 2 according to one embodiment. In the illustrated embodiment, by clicking on events 313, various features (e.g., background, first slide, second slide, third slide, etc.) may be offered as menu 325 to help the user with application generation through a series of simple feature building processes via user interface 251. For example, upon selecting a second slide option 321 from menu 325 of events 313, sub-menu 323 may be presented to offer and allow the user to choose to further define an event, such as by defining what a first slide or a double tap may represent and add a corresponding animation, color, etc. For example, a first slide, via first slide option 321, may be built to be used to perform any number and type of actions or events, such as triggering an opening of a file, bringing up of a login menu, moving in a direction, fading of a screen, etc., and similarly, tapping may be used to trigger zooming-in or zooming-out or closing of a screen, etc.

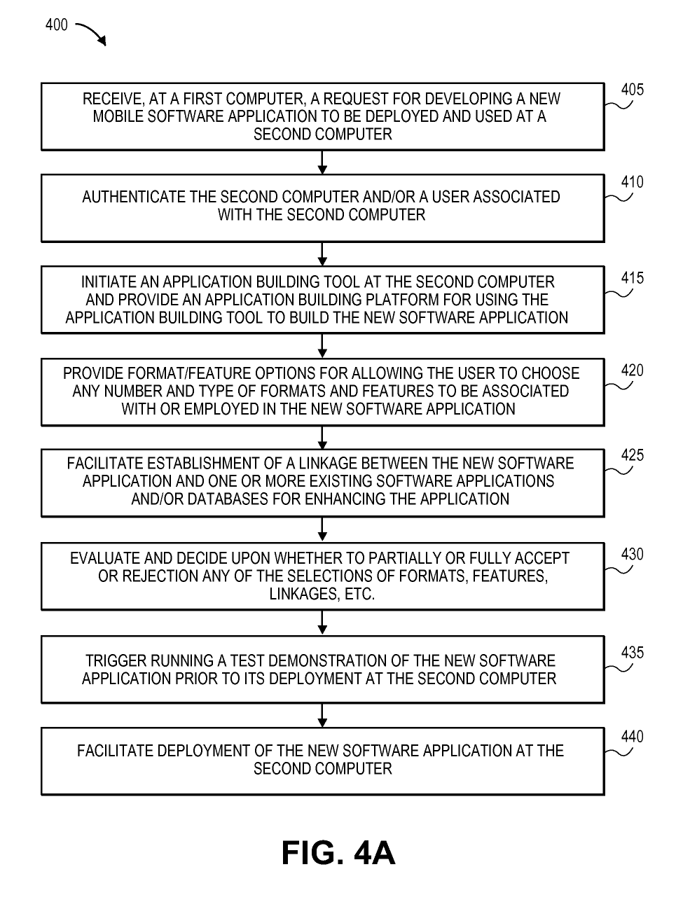

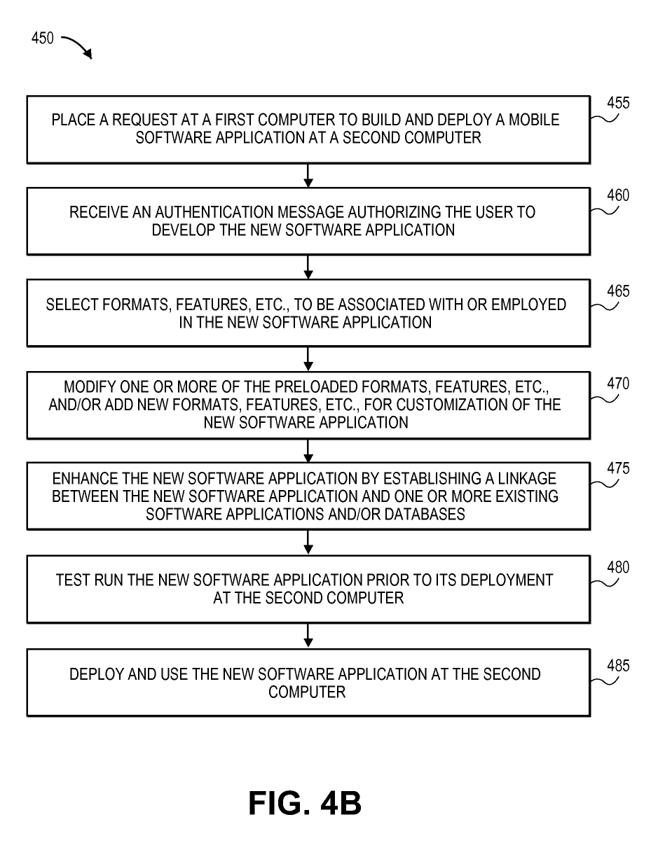

FIG. 4A illustrates a method 400 for facilitating dynamic software development at a mobile computing device according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by mobile mechanism 110 and/or building tool 240 of FIG. 2. The processes of method 400 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3D may not be repeated hereafter.

Method 400 begins at block 405 with receiving a request at a first computer, such as server computer 100 of FIG. 2, for developing a new mobile software application to be deployed and used at a second computer, such as client computer 200 of FIG. 2, including a mobile computing device, such as a tablet computer, a smartphone, etc. Upon receiving the request, the second computer and/or a user associated with the second computer are authenticated at block 410. In one embodiment, the new application may be developed at the second computer or in another embodiment, the new application may be created at one or more other computers, including mobile/non-mobile computers, and then deployed to be used at the second computer. In one embodiment, at block 415, upon successful authentication, an application building tool at the second computer is initiated and an application building platform (e.g., Heroku®, VisualForce®, etc.) is provided so that the application building tool may be used for building the new application via a user interface (e.g., Web browser, Photoshop-like browser, WYSIWYG interface, etc.).

At block 420, in one embodiment, various format and feature options may be facilitated and provided for development of the new application. In one embodiment, the process of block 420 may allow the user to select from any number and type of pre-loaded format/feature options, modify one or more of formats/features selected from the pre-loaded formats/feature options, and add or employ (e.g., upload) any number and type of additional formats and features that are personalized or customized for one or more of the user, an organization the user represents, and one or more potential clients, as desired or necessitated. At block 425, the new application may be further enhanced by establishing a linkage between the new application and one or more existing applications and/or databases. At block 430, any selections by the user with respect to the processes of blocks 420 and 425 are evaluated decided upon as to whether one or more of them ought to be fully or partially accepted or rejected. In one embodiment, at block 435, upon receiving a request for demonstration, the new application may be run and demonstrated for testing purposes prior to being deployed at the second computer. At block 440, upon receiving a request for deployment, the new application may be deployed and set ready to be used at the second computer.

FIG. 4B illustrates a method 450 for facilitating dynamic software development at a mobile computing device according to one embodiment. Method 450 may be performed by processing logic that may comprise hardware (e.g., circuitry, dedicated logic, programmable logic, etc.), software (such as instructions run on a processing device), or a combination thereof. In one embodiment, method 450 may be performed by mobile mechanism 110 and/or building tool 240 of FIG. 2. The processes of method 450 are illustrated in linear sequences for brevity and clarity in presentation; however, it is contemplated that any number of them can be performed in parallel, asynchronously, or in different orders. Further, for brevity, clarity, and ease of understanding, many of the components and processes described with respect to FIGS. 1-3D may not be repeated hereafter

Method 450 begins at block 455 with placing a request with a first computer, such as server computer 100 of FIG. 2, to create a new software application to then be deployed and used at a second computer, such as client computer 200 of FIG. 2. The request may be placed by a user by simply clicking on an icon representing building tool 240, such as icon 331 of FIG. 3A, and then initiating the process by registering and/or logging-in as illustrated in FIG. 3B. In one embodiment, the new application may be developed at the second computer or in another embodiment, at one or more other computers, including mobile computers and/or non-mobile computers, and then deployed to be used at the second computer. At block 460, an authentication message is received indicating that the user is authorized to proceed with the application building process.

At block 465, in one embodiment, the application building process may begin by having the user select any number and type of format, features, etc., from the pre-loaded set of format and feature options using block-by-block/step-by-step processes via a simplified user interface, such as user interface 251 as facilitated by user interface logic 219 of FIG. 2. At block 470, the user may choose to modify some the pre-loaded formatting and features options that are offered and/or add new formats or features events as necessitated or desired by the user. At block 475, in one embodiment, the user may choose to enhance the new application by associated it with one or more existing applications and/or databases having relevant content/database. As aforementioned with reference to FIG. 2, the new application may be associated such that the relevant content may be accessed on-the-fly, the new and one or more existing applications may be merged together, portions of the new application may be filled in by portions of one or more existing applications, an existing application may be used in its entirety as new application with minor changes, such as names, dates, addresses, etc.

In one embodiment, at block 480, the user may choose to test run the new application by selecting its demonstration. Upon choosing to ignore or run the test run demonstration, the new application may be deployed and used at the second computer at block 485.

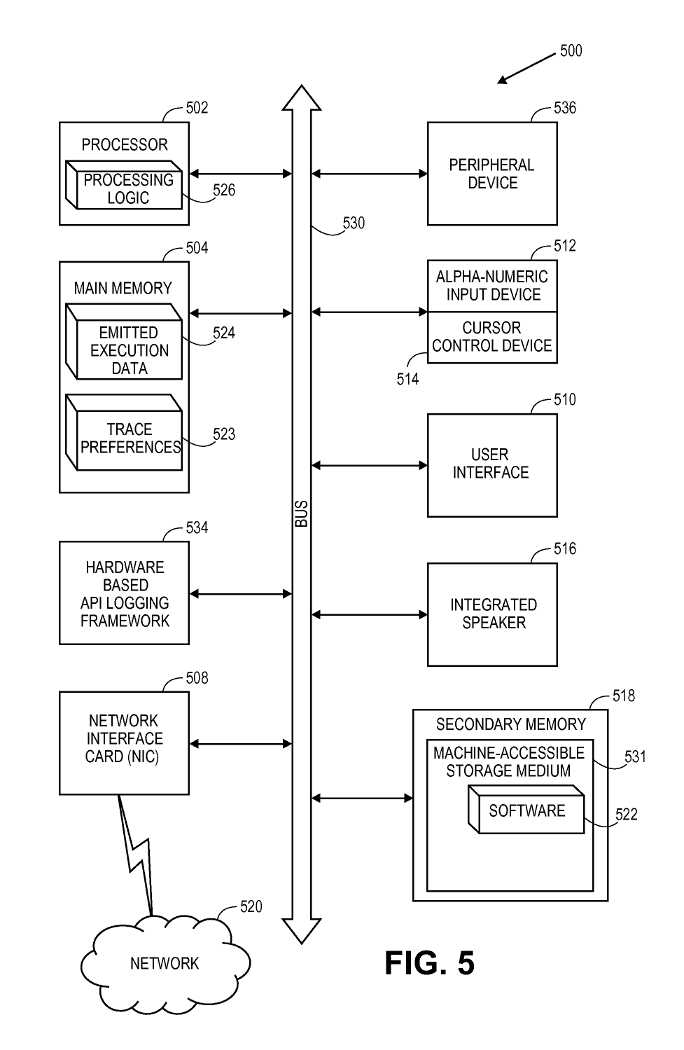

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 and computing device 200 of FIG. 1 and FIG. 2, respectively. In alternative embodiments, the machine may be connected (e.g., networked) to other machines in a network (such as host machine 100 of FIG. 1 connected with client machine 200 over network 235 of FIG. 2), such as a cloud-based network, Internet of Things (IoT) or Cloud of Things (CoT), a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of dynamic mobile software development mechanism 110 and application building tool 240 as described with reference to FIG. 1 and FIG. 2, respectively, and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of mobile mechanism 110 and/or building tool 241 as described with reference to FIG. 1 and FIG. 2, respectively, and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer -readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

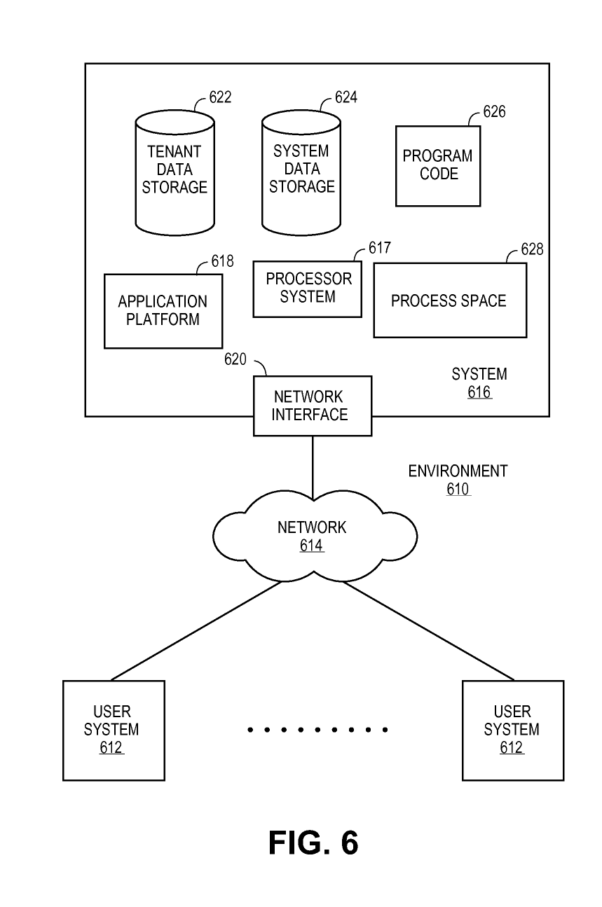

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

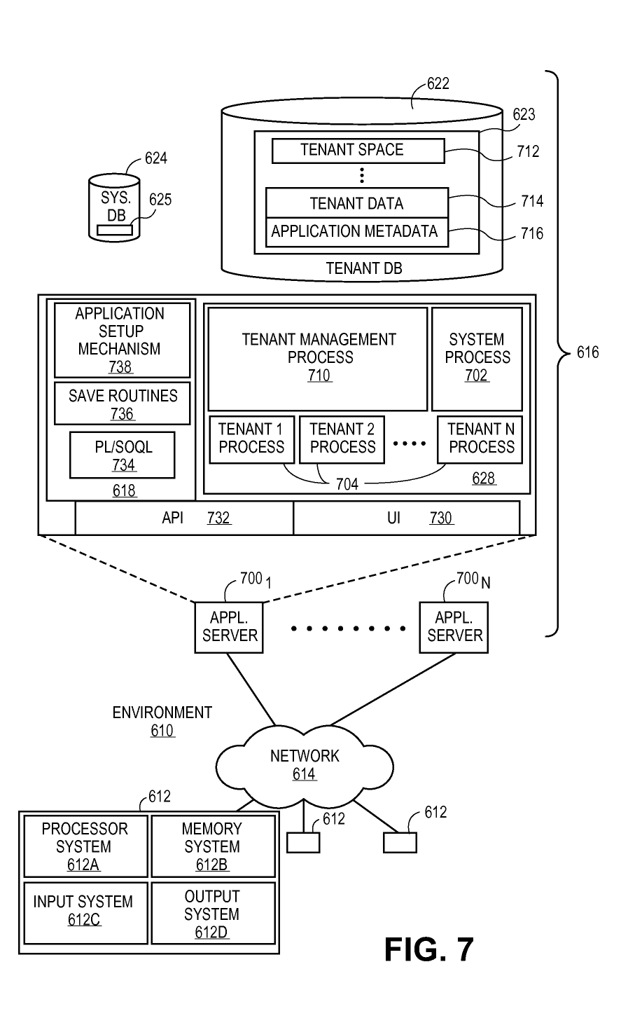

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
initiating an application building tool to generate a new software application for a computing device, wherein the application building tool is accessible via a user interface at the computing device including a mobile computing device or one or more other computing devices; and
providing a software development environment to facilitate user interactions based on the new software application, wherein each user interaction is associated with one or more objects in an on-demand services environment.

2. The method of claim 1, further comprising:
receiving a request for generating the new software application;
authenticating, in response to the request, at least one of the computing device and a user associated with the computing device; and
evaluating one or more processes relating to selection of at least one of formats and features to be employed by the new software application, wherein evaluating includes determining whether each of the one or more processes is to be partially or fully accepted or rejected.

3. The method of claim 1, wherein the one or more objects comprise one or more existing software applications or one or more databases having contents relevant to the new software application, wherein the user interactions include real-time communication between the new software application and the one or more existing software applications or the one or more databases via the software development environment.

4. The method of claim 1, further comprising offering preloaded format options and feature options having the formats and the features, respectively, to enhance the new software application.

5. The method of claim 1, further comprising:
initiating a test run of the new software application prior to its deployment at the computing device;
facilitating deployment of the software application at the computing device; and
facilitating sharing of the new software application via one or more communication applications, wherein the one or more communication applications include one or more of email applications, short message service (SMS) applications, and networking websites including one or more of Chatter®, Facebook®, and LinkedIn®.

6. A system comprising:
a processor and a memory to execute instructions at the system; and
a mechanism to:
initiate an application building tool to generate a new software application for a computing device, wherein the application building tool is accessible via a user interface at the computing device including a mobile computing device or one or more other computing devices, and
provide a software development environment to facilitate user interactions based on the new software application, wherein each user interaction is associated with one or more objects in an on-demand services environment.

7. The system of claim 6, wherein the mechanism is further to:
receive a request for generating the new software application;
authenticate, in response to the request, at least one of the computing device and a user associated with the computing device; and
evaluate one or more processes relating to selection of at least one of formats and features to be employed by the new software application, wherein evaluating includes determining whether each of the one or more processes is to be partially or fully accepted or rejected.

8. The system of claim 6, wherein the one or more objects comprise one or more existing software applications or one or more databases having contents relevant to the new software application, wherein the user interactions include real-time communication between the new software application and the one or more existing software applications or the one or more databases via the software development environment.

9. The system of claim 6, wherein the mechanism is further to offer preloaded format options and feature options having the formats and the features, respectively, to enhance the new software application.

10. The system of claim 6, wherein the mechanism is further to:
initiate a test run of the new software application prior to its deployment at the computing device;
facilitate deployment of the software application at the computing device; and
facilitate sharing of the new software application via one or more communication applications, wherein the one or more communication applications include one or more of email applications, short message service (SMS) applications, and networking websites including one or more of Chatter®, Facebook®, and LinkedIn®.

11. A machine-readable medium comprising a plurality of instructions which, when executed by a processing device, cause the processing device to perform one or more operations comprising:
initiating an application building tool to generate a new software application for a computing device, wherein the application building tool is accessible via a user interface at the computing device including a mobile computing device or one or more other computing devices; and
providing a software development environment to facilitate user interactions based on the new software application, wherein each user interaction is associated with one or more objects in an on-demand services environment.

12. The machine-readable medium of claim 11, wherein the one or more operations further comprise:
receiving a request for generating the new software application;
authenticating, in response to the request, at least one of the computing device and a user associated with the computing device; and
evaluating one or more processes relating to selection of at least one of formats and features to be employed by the new software application, wherein evaluating includes determining whether each of the one or more processes is to be partially or fully accepted or rejected.

13. The machine-readable medium of claim 11, wherein the one or more objects comprise one or more existing software applications or one or more databases having contents relevant to the new software application, wherein the user interactions include real-time communication between the new software application and the one or more existing software applications or the one or more databases via the software development environment.

14. The machine-readable medium of claim 11, wherein the one or more operations further comprise offering preloaded format options and feature options having the formats and the features, respectively, to enhance the new software application.

15. The machine-readable medium of claim 11, wherein the one or more operations further comprise:
initiating a test run of the new software application prior to its deployment at the computing device;
facilitating deployment of the software application at the computing device; and
facilitating sharing of the new software application via one or more communication applications, wherein the one or more communication applications include one or more of email applications, short message service (SMS) applications, and networking websites including one or more of Chatter®, Facebook®, and LinkedIn®.

16. A system comprising:
a computing device having a processor and a memory to execute instructions at the system; and
an application building tool to:
generate, via a user interface, a new software application at the computing device including a mobile computing device, wherein generating includes selecting one or more of formats and features to be employed in the new software application, and
deploy the new software application at the computing device in an on-demand services environment.

17. The system of claim 16, wherein the application building tool is further to test run the new software application prior to its deployment at the computing device.

18. The system of claim 16, wherein the application building tool is further to:
modify one or more of the formats and features, wherein the one or more of the formats and feature are received as pre-loaded format options and features options having the formats and the features, respectively; and
introduce one or more of personalized formats and personalized features to the preloaded format and feature options to customize the new software application.

19. The system of claim 16, wherein the application building tool is further to:
initiate establishment of user interactions based on the new software application, wherein each user interaction is associated with one or more objects in the on-demand services environment; and
facilitate sharing of the new software application via one or more communication applications, wherein the one or more communication applications include one or more of email applications, short message service (SMS) applications, and networking websites including one or more of Chatter®, Facebook®, and LinkedIn®.

20. The system of claim 19, wherein the one or more objects comprise one or more existing software applications or one or more databases having contents relevant to the software application, wherein the user interactions include real-time communication between the new software application and the one or more existing software applications or the one or more databases using the software development environment.
